(19) United States
(12) Patent Application Publication
(10) Pub. No.: US 2014/0108133 A1
(43) Pub. Date: Apr. 17, 2014

(54) SWAPPING MAGAZINE SELF MAILER ARRANGED BY THIRD PARTY IRS COMPLIANT

(71) Applicant: Manuel E. Chavez, Albuquerque, NM (US)

(72) Inventor: Manuel E. Chavez, Albuquerque, NM (US)

(21) Appl. No.: 13/654,297

(22) Filed: Oct. 17, 2012

(51) Int. Cl. G06Q 30/02

(52) U.S. Cl. 705/14.46

(57) ABSTRACT

A system and method for swapping self-mailer inserts and reporting an income with respect to the self-mailer inserts to an IRS (internal revenue service). A self-mailer insert having a return address addressed to a third party can be attached with a magazine. A swapping insert placement order for swapping the self-mailer insert between two or more magazines can be processed by the third party and recorded to a database. A returned insert along with a cash payment from a new subscriber for a new magazine can be received by the third party for processing and data collection and recorded to a database. A report statement including the cash payment enclosed with the returned insert can be reported back to the magazine company by querying the database. The cash payment received from the returned insert for each magazine can also be reported as a reportable income to the IRS.

### CROSS-REFERENCE TO PROVISIONAL PATENT APPLICATION

This patent application claims the benefit under 35 U.S.C. §119(e) of U.S. Provisional Application Ser. No. 61/550,579 entitled, “Compliance Reporting With Magazine Swap Magazine Inserts Utilizing Self Mailers and a Third Party,” which was filed on Oct. 24, 2011 and is incorporated herein by reference in its entirety.

### TECHNICAL FIELD

Embodiments are generally related to the management in the solicitation and processing of magazine subscriptions by a third party. Embodiments are also related to magazine subscription inserts utilized in the marketing of magazines that adequately meet the IRS reportable income requirements. Embodiments are additionally related to techniques, devices, database and systems for swapping magazine inserts and implementing compliance reporting thereof.

### BACKGROUND OF THE INVENTION

Note: This invention in no way tries to reduce, avoid or defer tax liability, recently Congress passed the Leahy-Smith America Invents Act with SEC. 14. TAX STRATEGIES DEEMED WITHIN THE PRIOR ART. here any strategy for reducing, avoiding, or deferring tax liability, whether known or unknown at the time of the invention or application for patent, shall be deemed insufficient to differentiate a claimed invention from the prior art. There is an exception for patent on tax strategies which is, methods, apparatus, technology, computer program product, or system, that is used solely for preparing a tax or information return or other tax filing, including one that records, transmits, transfers, or organizes data related to such filing.

More than forty seven years ago, it was common for Consumer Magazine Publishers to swap a subscription insert freely with one another. Example Life Magazine would place free subscriber postcards into National Geographic Magazine and National Geographic would correspondingly place Life Magazine subscription postcards in their magazine, they freely swapped inserts with each other, that solicited a new subscriber for a different magazine publisher. But the Internal Revenue Service, IRS, ruled around 1968, that these insert's were barter i.e., barter is exchanging an object for no money, and therefore were tax reportable income, this practice ceased after that ruling. It, the IRS ruling, required them to file 1099b forms when more $200 in value where exchanged. This was a multimillion dollar revenue industry in 1965 but the magazine freely swapping insert industry ceased by 1970 because of the IRS ruling that this particular type of swapping of inserts were barter and required the reporting of tax reportable income.

### Unsolved Problem

For the past forty seven years no method or system has been presented which solved and satisfied the IRS ruling that this particular type of swapping of inserts were barter and required the reporting of tax reportable income, where two different consumer magazine publishers can place inserts with each other freely and also satisfy compliance with the IRS ruling.

### Problem Solved with Disclosed Method

This Invention solves and shows a method and a system that can. That is when swapping inserts between two magazines that are owned by different magazine publishers one can both swap freely and also overcome the IRS ruling i.e., particular inserts were barter, an required tax reportable income to be reported. One essential item is to use self-mailer inserts that has an envelope where a check or credit card number is enclosed that require immediate cash payment rather than using business reply postcards inserts. Another important item is to address returned self mailer inserts to a Third party for processing where data and payments from inserts is placed in a database, were the database can be queried for IRS reports. Still another important item to exchange or swap of inserts on a cash and a per-inquiry basis were a sale takes place immediately i.e., a order is placed, and money is exchanged when a new subscription is ordered. This is done by requiring immediately a enclosed check or credit card number, a phone call with credit card number when placing a order for a new magazine subscription by way of the self mailer insert. A sale is an exchange of an object for money while barter is a exchange of an object with no money. The IRS desires business to conduct business when exchanging things as a sale and not barter. Therefore if one does not use bartering of inserts but uses exchanging of inserts as a sales where money is exchanged for objects i.e., inserts, one can overcome the IRS ruling. Therefore one may now swap inserts on sale basis, not as barter, on a per inquiry basis where money is exchanged on placement of a order for a new subscription, this will bring back an industry of swapping of insert back into existence that once exited but no longer exist. Still another second embodiment is having a third party collect data if a bartering of inserts takes place between magazine where a third party is respond able for reporting reportable income on behalf of magazine this is done by placing insert data in a database and queuing database for report that are sent to IRS. This also overcomes the IRS ruling, here a third party is responsible for collecting data if a barter takes i.e., not a sale, places and reporting reportable income to the IRS.

In advertising, an insert or blow-in card is typically a separate advertisement put in a magazine, newspaper, or other publication. Such implements are usually the one main source of income for subscription to magazines and other publications. Magazine inserts that solicit a new subscriber constitute an effective technique for a publisher to distribute information to a wide array of customers. Magazine inserts can be utilized to acquire a new subscriber, an introduce new product, publicize a special promotion or even initiate an advertising campaign.

Many insert programs can be scheduled for placement in a variety of publications, and each publication have its own set of production specifications. Certain groups of consumers can be targeted more specifically through the magazine inserts. The usage of such magazine inserts must be monitored as the magazine inserts when bartered are considered as a tax reportable income by the IRS (Internal Revenue Service) ruling.

Based on foregoing, it is believed that a need exists for an improved system and method for swapping self-mailer inserts between magazines via a third party and exchanging inserts on a sale basis i.e., where inserts are exchanged for money payment. A need also exists for an improved method for reporting an income with respect to the insert to IRS used solely for preparing a tax filing, as will be described in greater detailed herein. Also a second embodiment based on foregoing, it is believed that a need exists for an improved system and method for swapping self-mailer inserts between magazines via a third party and exchanging inserts on a barter basis i.e., where inserts are exchanged with no money payment by magazine company and where a third party collects insert data and places it database and quires database for reports to IRS of reportable incomes i.e., 1099b form 600 or 1099misc. form, not shown

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved solicitation of magazine subscription management systems and methods.

It is another aspect of the disclosed embodiments is to reestablish an industry that once existed but no longer exist of swapping inserts between different magazine publishers that solicit new subscriber for a magazine.

It is another aspect of the disclosed embodiments to provide for an improved system and method for swapping self-mailer inserts between magazines via a third party.

It is further aspect of the disclosed embodiments to provide for an improved method for reporting an income with respect to the self-mailer insert to IRS (Internal Revenue Service).

It is further aspect of the disclosed embodiments to provide for an improved management method and system which simultaneously arranges the placement of inserts into thousands of different magazines and simultaneously where everything is accounted for.

It is further aspect of the disclosed embodiments to provide for an improved management method and system where a third party can handle and process millions of returned inserts from different magazines simultaneously

The aforementioned aspects and other objectives and advantages can now be achieved as described herein. A system and method for swapping self-mailer inserts and reporting an income with respect to the self-mailer inserts to IRS is disclosed herein. A self-mailer insert having a return address addressed to a third party can be attached with a magazine. An exchange of self mailers inserts between different magazine by agreement on a per-inquiry sale basis that solicits a new subscriber can be arranged each may add a commission for host magazine. A swapping insert placement order for swapping the self-mailer insert between two or more magazines can be processed by the third party and recorded to a database. A returned insert along with a cash payment from a new subscriber for a new magazine can be received by the third party for processing and data collection and recorded to a database. A report statement including the cash payment enclosed with the returned insert can be reported back to the magazine company by querying the database. The cash payment received from the returned insert for each magazine can also be reported as a reportable income to the IRS 1099misc form not shown. Such an approach can reestablish a magazine insert swapping industry and satisfy compliance with the IRS ruling. A second embodiment may be An exchange of self mailers inserts between different magazine by agreement on a per-inquiry barter basis that solicits a new subscriber can be arranged by a third party each may add a commission for host magazine. A swapping insert placement order for swapping the self-mailer insert between two or more magazines can be processed by the third party and recorded to a database. A returned insert along with a cash payment from a new subscriber for a new magazine can be received by the third party for processing and data collection and recorded to a database. A report statement including the cash payment enclosed with the returned insert can be reported back to the magazine company by querying the database. The cash payment received from the returned insert for each magazine can also be reported as a reportable income to the IRS 1099b form 600. Such an approach can reestablish a magazine insert swapping industry and satisfy compliance with the IRS ruling.

The self-mailer insert includes an enclosed envelope having a check that can be mailed by the subscriber for subscription of the new magazine. The self-mailer data for example, third party address information (e.g., the third party name, address, state, zip code), insert identification, check or credit card information, the new subscriber address information and insert magazine title can be placed into the database. The third party arranges the swap placement order for the self-mailer inserts between two or more magazines which desires to swap the inserts between themselves. The inserts can be made by a layout sent to a receiving magazine where the receiving magazine takes responsibility to make and insert into the magazine. The insert can be made just in time and/or the insert can be pre-made by the insertion requesting magazine company and sent to a receiving placement magazine company for insertion to the receiving magazine.

The report statement includes data for example, amount received, price minus processing fee, commission fees, and amount remitted. The database includes data indicative of the self-mailer inserts, the returned self-mailer, the new subscribers and the magazine title. The reportable income with respect to the returned insert with payment can be queried from the database. The total payment received from the returned insert per magazine publisher can be reported to the IRS. The database (e.g., commercial and open source database management system (DBMS)) is capable of taking in data and generating the reports for the magazine statement and sends the reportable income for each magazine to the IRS.

Now explaining more fully the aspect of the system said system for swapping self-mailer inserts, said system would comprise a self-mailer insert management system that includes a third party server, with a self-mailer insert management module, and a database connected to an internal revenue service and a magazine company via a network, the self-mailer insert management module includes a self-mailer insert swapping and placement unit that places and swaps inserts, a Return Insert-Cash Payment Processing unit that process payment of return inserts, a internal revenue service Reporting Unit that complies reports for the internal revenue service.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a self-mailer insert management module, an operating system, and a user interface, in accordance with the disclosed embodiments;

FIG. 3 illustrates a block diagram of a self-mailer insert management system, in accordance with the disclosed embodiments;

FIG. 4 illustrates a high level flow chart of operations illustrating logical operational steps of a method for swapping self-mailer inserts and reporting an income with respect to the self-mailer inserts to IRS, in accordance with the disclosed embodiments;

FIG. 5 illustrates a perspective view of a self-mailer insert with a return address addressed to a third party, in accordance with the disclosed embodiments;

FIG. 6 illustrates a perspective view of two magazines swapping self-mailer inserts between themselves, in accordance with the disclosed embodiments;

FIG. 7 illustrates an exemplary swapping insert placement order generated by a third party for swapping the inserts between two or more magazines, in accordance with the disclosed embodiments;

FIG. 8 illustrates an exemplary report statement prepared by the third party, in accordance with the disclosed embodiments;

FIGS. 9-10 illustrate an exemplary report form sent to the IRS of cash payment received for each returned inserts, in accordance with the disclosed embodiments;

FIGS. 11-12 illustrate an exemplary open source database management system (DBMS) and a flat database capable of generating reports for the magazine company and the IRS, in accordance with the disclosed embodiments; and

FIGS. 13-14 illustrate an exemplary view of a database schema for taking in data and generating reports for the magazine company and the IRS, in accordance with the disclosed embodiments.

### DETAILED DESCRIPTION

### Written Description

This written description describes what the invention is and will clearly convey what the inventor considers his invention to be, to a person skilled in the art. We start with a overview and continuing with increasing levels of detail. This will guide the reader such as a person skilled in the art to a full description of invention i.e., embodiments. The written description with, how to make and use it, will also discloses and teaches the claimed subject matter, by guiding the reader to continuing increasing levels of details and also makes clear the specification as a whole discloses and teaches each and every claim.

Now turning to the overview that describes what the invention is: this invention is a method and system when implemented allows two or more different magazine to exchange inserts 450, 309 called self mailers that solicits a new subscriber with each other, that is arranged by way of a third party 149, 232. The third party 149, 232 arranges the exchanges of inserts, on a per inquiry payment sale basis. In another embodiment the third party 149,232 arranges the exchange of inserts, on a barter basis, and collects data of inserts 225 places it database 285 ques database 800 for IRS reportable income statements 1099b 650. The third party 149, 232 then places a placement order 240 to each magazine where each magazine produces inserts then ship them to the other magazine to be place in there magazines. The order 240 can be on a sale exchange basis or barter basis. Return inserts 260 are addressed to third party 412 for processing. The third party 149, 232 records data from returned inserts 260 place it a database 285 and cash payment received 265. The third party then quires the database 285 for reports to each magazine 250 and reports to IRS 600 and fulfillment house. Now turning to the system, the system allows handling of data when two or more magazine inserts are exchanged 450,309 this includes placement order data 240, returned insert 260 data, payment received data 265, by queering said data from the database 285, statement reports 250 to each magazine and reports to IRS 275 and fulfillment house reports can be generated. A person skill in art we notice that such a system disclosed, here and later, is able can handle thousands of magazines swaps simultaneously and process millions of returned inserts simultaneously. Further written description is disclosed below.

### 1. DEFINITIONS

Barter as used herein shall mean to give and receive reciprocally with no money involved. In particular as used herein shall mean to give self mailers inserts that are placed in another magazine and receive inserts from another magzine that are placed in your magzine reciprocally with no money involved. A Sale as used herein shall mean to give an object and receive money reciprocally. In particular as used herein shall mean to give or place self mailers inserts in another magzine that solicits a order for a new magazine and if solicitation is successful receive a order that includes immediate money payment.

Generally an Exchange or Swapping as used herein shall be define in two ways: One way means to give an object and receive money reciprocally. In particular an Exchange or Swapping as used herein shall mean to give or place an self mailer insert into another magazine and receive money reciprocally on a per inquiry basis; in addition to is used herein shall mean that this also would constitutes a sale on a per inquiry basis. A second way means generally an Exchange or Swapping as used herein shall mean to give one object for another object without money. In particular an Exchange or Swapping; as used herein shall mean to mutually give or place self mailers insert between different magazines and receive no payment money for allowing insertion of inserts into ones magazine; in addition to is used herein shall also mean that this would also constitutes a barter.

Self mailer insert as used herein shall mean an insert in magazine that solicit a magazine subscription that has a built in envelope where on can place a check or credit card number and mail it or go to a website or phone and receive a new subscription to a magazine, this would also include taking subscriber name address.

Third Party is as used herein shall mean a party that arranges an exchange or swapping of self mailers between magazines having a third party address as returned address and processing returned self mailer insert.

Different magazine is used herein shall mean magazines that are from different magazine publishers.

### The Mode of How to Operate Invention

The Third Party 149 staff arranges a Exchange/Swapping Insert Placement order 240 with a magazine publisher 860. Data from return self mailer insert 260,432,430 are entered into the database 285 by way of the third party server 210. The database 285 is queried for monthly statements 250 for each magazine publisher 860 also the database 285 is queried for tax reportable income 600 for each magazine publisher 860 and periodically sent to IRS 290 1099b forms 600 or 1099misc forms not shown.

### 3. BEST MODE OF INVENTION

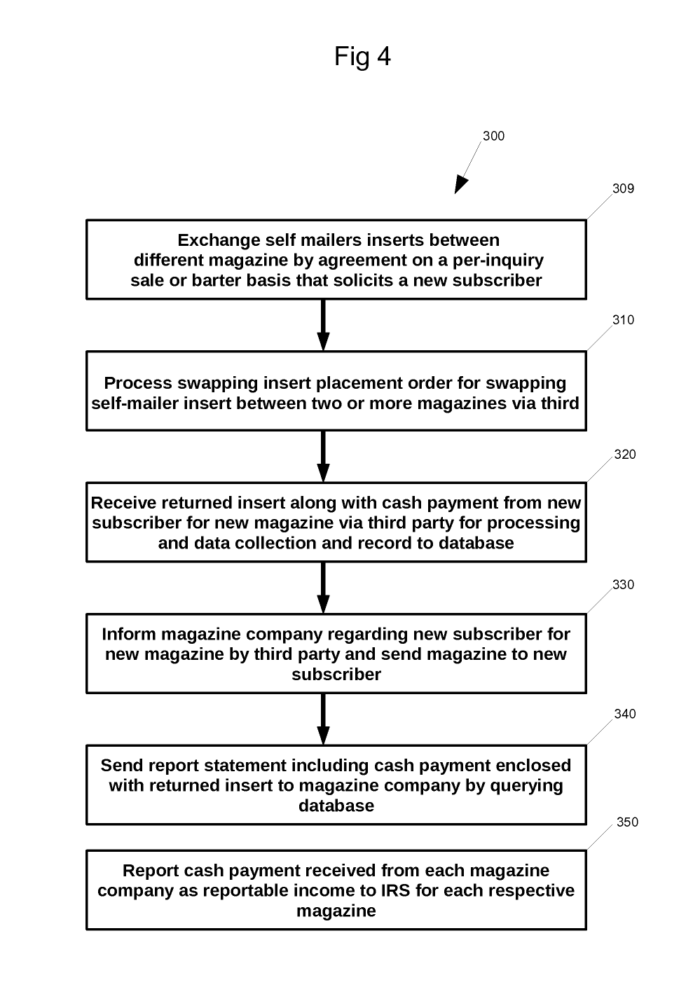

FIG. 4 shows an illustrates a high level flow chart of operations view of the best mode contemplated by the inventor of the method according to the concepts of the present invention.

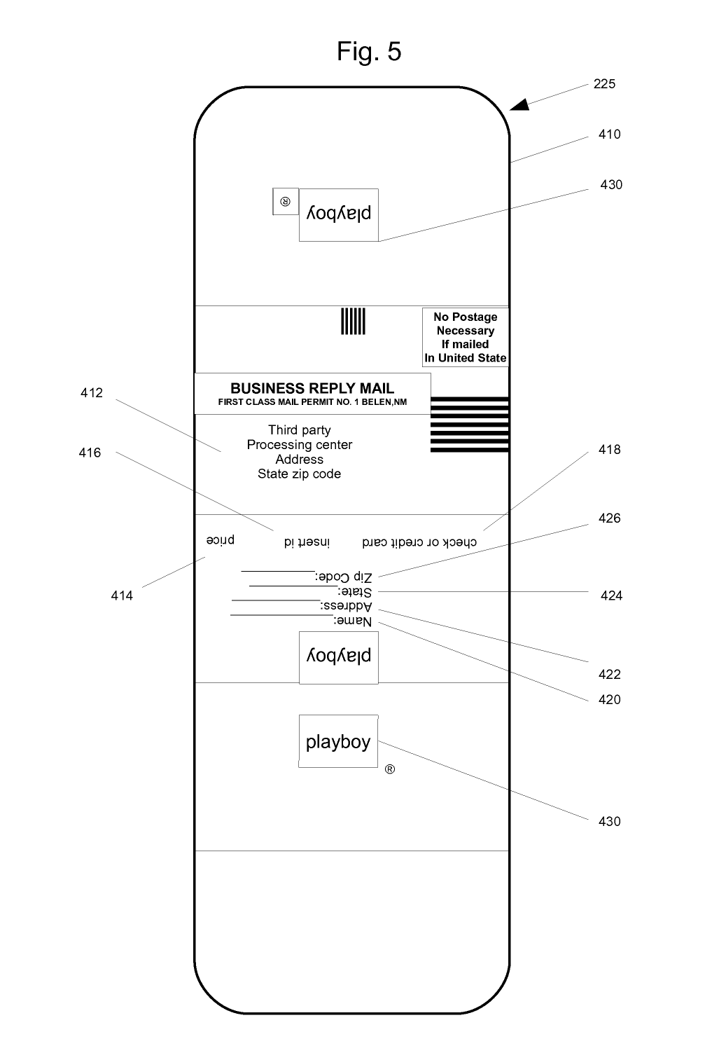

FIG. 5 shows an illustrates a block diagram of a self-mailer insert management system view of the best mode contemplated by the inventor of the system according to the concepts of the present invention.

Both FIG. 4 and FIG. 5 shows the entire view of the best mode of contemplated by the inventor for both the system and method.

Authors for preparing this application are Manuel E. Chavez and Kermit Lopez patent Attorney

Inventor for this application is solely inventor Manuel E. Chavez

### 4. HOW TO MAKE THE INVENTION

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

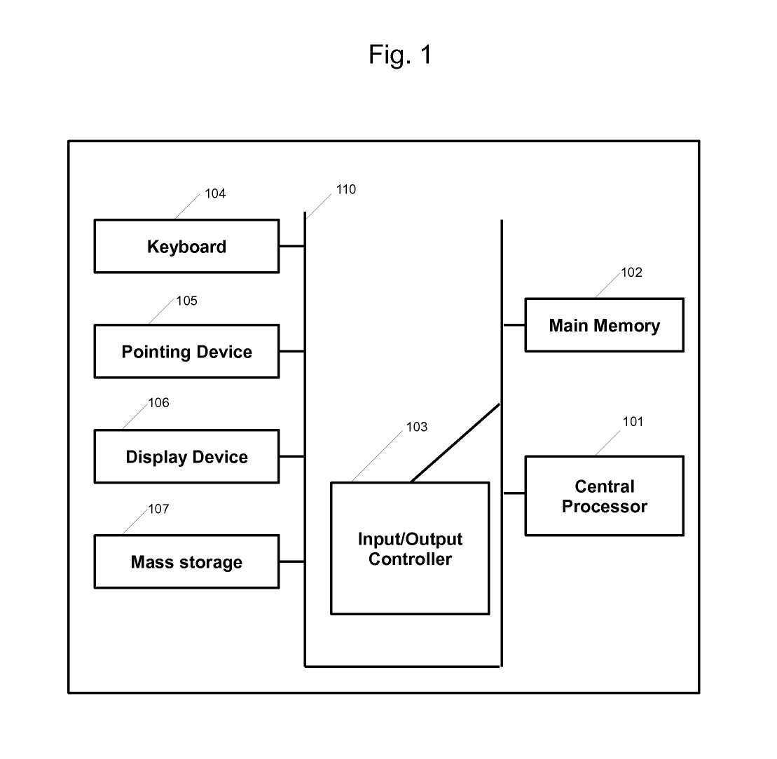

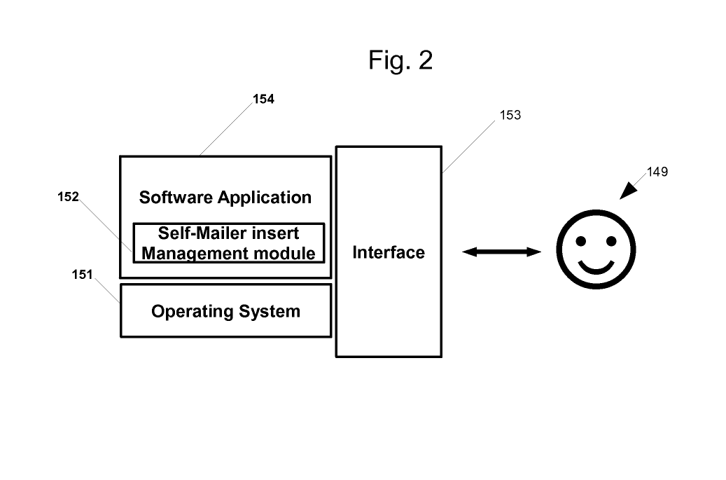

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, and pen device, etc.), a display device 106, a mass storage 107 (e.g., a hard disk), and a USB (Universal Serial Bus) peripheral connection 111. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data processing system 100 receives user commands and data through user interface 153; these inputs may then be acted upon by the data-processing system 100 in accordance with instructions from operating system module 152 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 153. The software application 154 can include a self-mailer insert management module 152 for swapping self-mailer inserts and reporting income with respect to the self-mailer inserts to an IRS (Internal Revenue Service). Software application 154, on the other hand, can include instructions, such as the various operations described herein with respect to the various components and modules described herein, such as, for example, the method 300 depicted in FIG. 4.

FIGS. 1-2 are thus intended as examples, and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

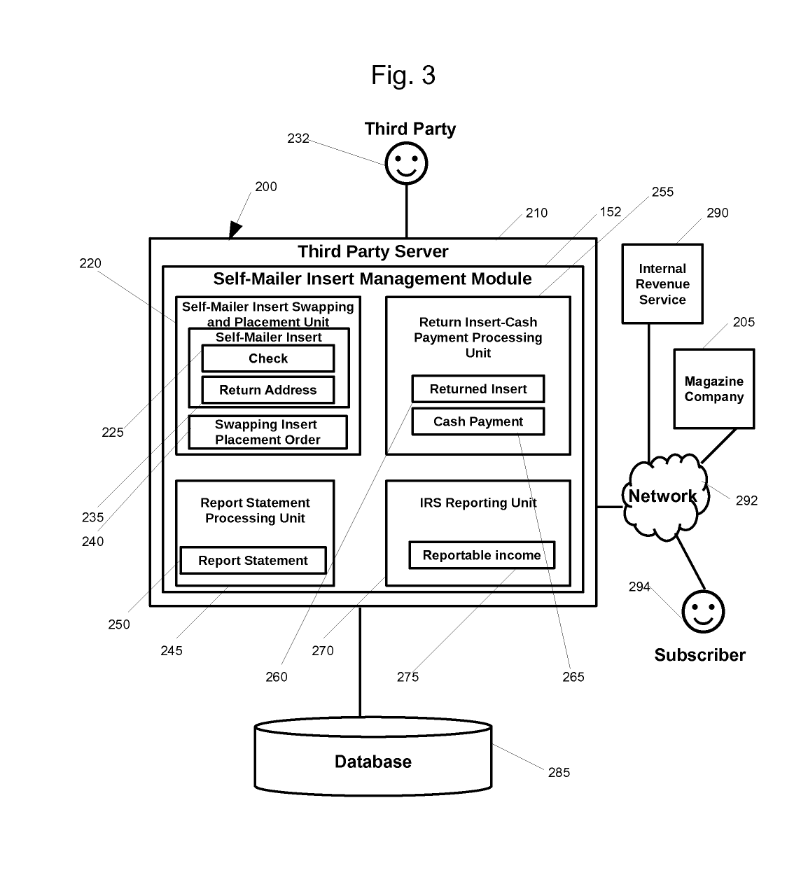

FIG. 3 illustrates a block diagram of a self-mailer insert management system 200, in accordance with the disclosed embodiments Note that in FIGS. 1-14, identical or similar blocks are generally indicated by identical reference numerals. The self-mailer insert management system 200 generally includes a third party server 210 having the self-mailer insert management module 152 and a database 285 connected to an internal revenue service 290 and a magazine company 205 via a network 292.

Note that the network 292 may employ any network topology, transmission medium, or network protocol. The network 292 may include connections, such as wire, wireless communication links, or fiber optic cables. Network 292 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages such as cloud computing, e-mail or FTP file transfer protocol or old fashion postal mail.

The self-mailer insert management module 152 further includes a self-mailer insert swapping and placement unit 220, a return insert cash payment processing unit 255, a report statement processing unit 245, and an IRS reporting unit 270. It can be appreciated that the self-mailer insert swapping and placement unit 220, the return insert cash payment processing unit 255, the report statement processing unit 245, and the IRS reporting unit 270 can be implemented as software modules. Note that the information from a subscriber 294 and the magazine company 205 can be communicated to the third-party server 210 and the IRS 290 through a third party 232.

The self-mailer insert swapping and placement unit 220 includes a self mailer insert 225 having a check 230 and a return address 235. The self mailer insert 225 can be mailed by the subscriber 294 to the return address 235 for subscription of a new magazine. Note that the subscriber 294 generally refers to an individual wishing to receive subscriptions to a magazine. A new subscriber 294 is a subscriber 294 who has placed a current subscription for a requested magazine and has not received such subscription for a predetermined time period (i.e., more than a month, more than year, ever, etc.). A new subscription is an order for delivery of magazine issues for the new subscriber 294. It should be noted that the term magazine may include other printed publications including, but not limited to, newsletters, trade publications, etc.

A swapping insert placement order 240 for swapping the self-mailer insert 225 between two or more magazines can be generated by the third party 232 and recorded to the database 285. Note that the database can be for example, a flat database or an open source database management system (DBMS), depending upon design considerations. The self-mailer insert 225 can be for example, a blow-in insert, depending upon design consideration. The magazine subscriber 294 can find the self-mailer insert 225 in the magazine and can subscribe the new magazine by filling out the insert 225 and enclosing the check 230 or credit card number and mailing out the insert 225 to the return address 235. The return insert-cash payment processing unit 255 receives a returned insert 260 along with a cash payment 265 from the new subscriber 294 for a new magazine for processing and data collection and recorded to the database 285. The magazine company 205 receives the new subscriber 294 requests from the third party 232 and starts sending the magazine by mail to the new subscriber 294.

The report statement processing unit 245 generates a report statement 250 including the cash payment 265 enclosed with the return insert 260 and send the report statement 250 to the magazine company 205 by querying the database 285. The IRS reporting unit 270 reports the cash payment 265 received from each magazine company 205 as a reportable income 275 to the IRS (Internal Revenue Service) 290 for each respective magazine. Again as reminder, the information from the subscriber 294 and the magazine company 205 can be communicated to the third-party server 210 and the IRS 290 through the third party 232.

FIG. 4 illustrates a high level flow chart of operations illustrating logical operational steps of a method 300 for swapping the self-mailer inserts 225 and reporting income with respect to the self-mailer inserts 225 to the IRS 290, in accordance with the disclosed embodiments. It can be appreciated that the logical operational steps shown in FIG. 4 can be implemented or provided via, for example, a module such as module 152 shown in FIG. 2 and can be processed via a processor, such as, for example, the processor 101 shown in FIG. 1. The swapping insert placement order 240 for swapping the self-mailer insert 225 between two or more magazines can be processed by the third party 232 and recorded to the database 285, as illustrated at block 310.

The logical operational steps shown in FIG. 4 include to exchange or exchanging self mailers inserts between different magazine by agreement on a per-inquiry sale basis that solicits a new subscriber 309 this is done by calling for a enclosed check or credit card number when placing a order for a new magazine subscription, a second embodiment may be to exchange or exchanging self mailers inserts between different magazine by agreement on a per-inquiry barter basis that solicits a new subscriber 309 this is done by having a third party place a placement order as barter of said inserts and having third party collect all data of revenue of returned inserts that is reported to IRS and calling for a enclosed check or credit card number when placing a order for a new magazine subscription, to process or processing swapping insert placement order for swapping self-mailer insert between two or more magazines via third 310, to receive or receiving returned insert along with cash payment from new subscriber for new magazine via third party for processing and data collection and record to database 320, to inform or informing magazine company regarding new subscriber for new magazine by third party and send magazine to new subscriber 330, to send or sending report statement including cash payment enclosed with returned insert to magazine company by querying database 340, to report or reporting cash payment received from each magazine company as reportable income to IRS for each respective magazine 350.

FIG. 5 illustrates a perspective view of the self-mailer insert 225 with the return address 235 addressed to the third party 232, in accordance with the disclosed embodiments. The self-mailer insert 225 includes an enclosed envelope 410 and the check 230 for payment. The self-mailer insert 225 also provides a place for the new subscribers 294 to enter data such as, for example, name 420, address 426, state 422, zip code 424, price 414 and an insert id 416. The self-mailer 410 can be filled and mailed to the third party 232 by the subscriber 294. The self-mailer insert 225 also includes data for example, the third party name, address, state, zip code 412, check or credit card details 418 and insert magazine title 430. The data indicative of the self-mailer insert 225 can be stored into the database 285.

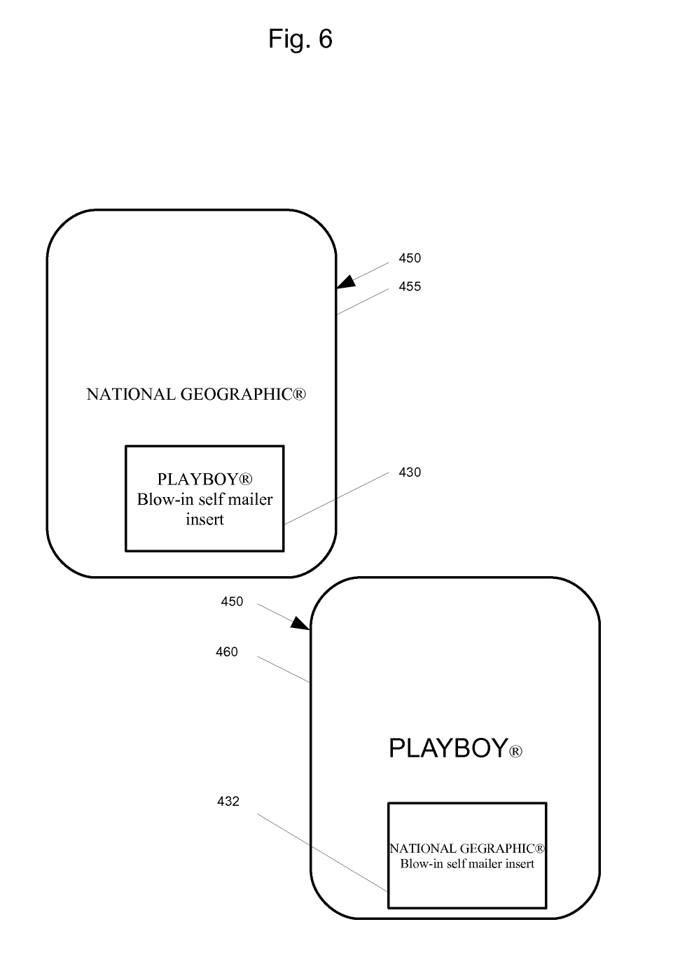

FIG. 6 illustrates a perspective view of two magazines 455 and 460 swapping self-mailer inserts 432 and 430 between themselves as a sale on a per-inquiry basis 309 a enclosed check or credit card number when placing a order for a new magazine subscription is call for, in accordance with the disclosed embodiments. For example, the National Geographic magazine 455 places the self-mailer inserts 432 with respect to for example, a magazine such as the PLAYBOY magazine 460. The PLAYBOY magazine 460 places the self-mailer inserts 430 with respect to, for example, the National Geographic magazine 455. The third party 232 arranges the swap placement order 240 for the self-mailer inserts 225 between the two magazines which desire to swap the inserts 225 between themselves.

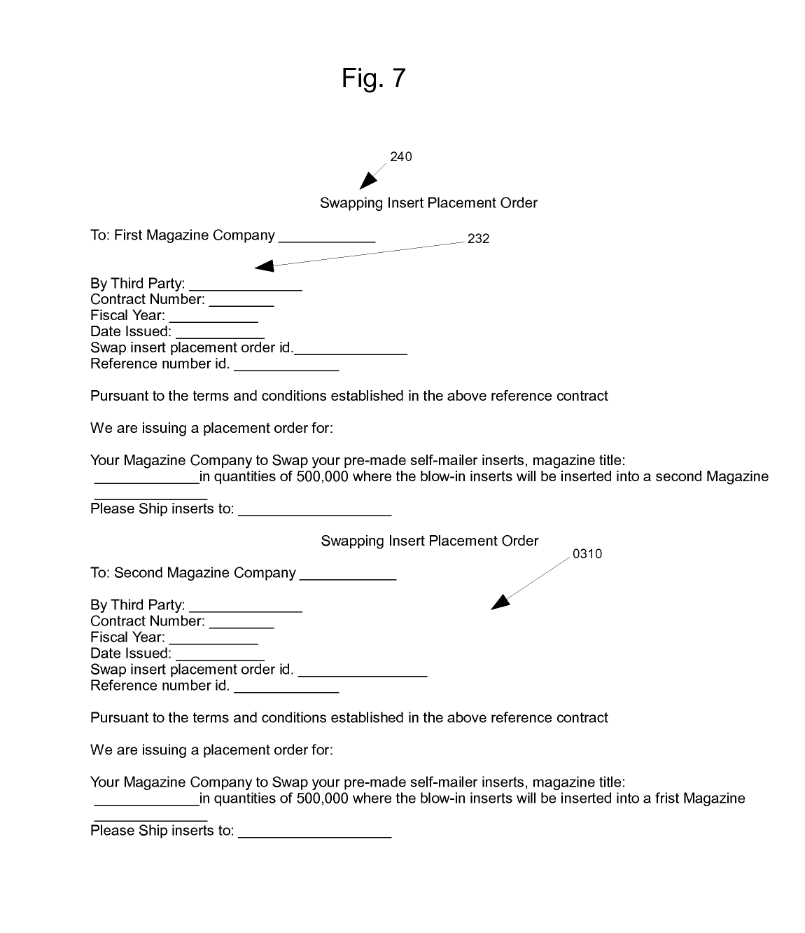

FIG. 7 illustrates an exemplary swap placement order 240 generated by the third party 232 for swapping the inserts 225 between two or more magazines, in accordance with the disclosed embodiments. The third party 232 has a list of magazines and matches two or more magazines from the list and receives approval from both magazine companies to swap the inserts 225. The third party 232 then issues the swap placement order 240 directing each company to place the inserts 225 of another magazine into their magazine. For example, the inserts 225 can be made by either a layout sent to a receiving magazine where the receiving magazine takes responsibility to make and insert into the magazine. The insert 225 can be made just in time or the insert 225 can be pre-made by an insertion requesting magazine company and sent to a receiving placement magazine company for insertion to the receiving magazine.

The returned insert 260 along with the cash payment 265 from the new subscriber 294 for the new magazine can be received by the third party 232 for processing and data collection and recorded to the database 285, as depicted at block 320. The processing includes opening the insert 260 taking a check or a credit card 418 number as payment and recording it to the database 285. The magazine company 205 can be informed regarding the new subscriber 294 for new magazine by the third party 232 and the magazine can be sent to the subscriber 294, as indicated at block 330. Thereafter, as indicated at block 340, the report statement 250 including cash payment enclosed with the returned insert 260 can be sent back to the magazine company 205 by querying the database 285.

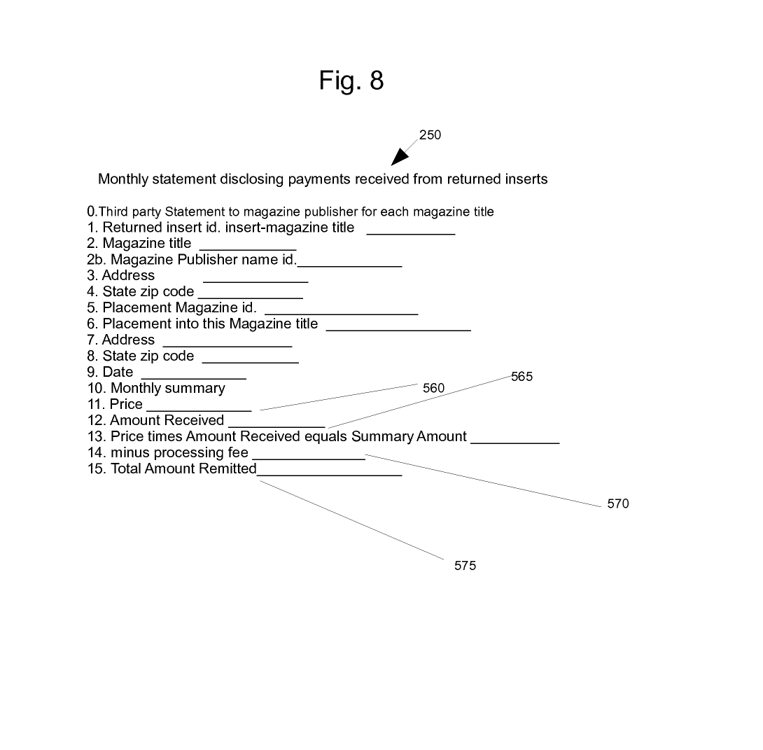

FIG. 8 illustrates an exemplary report statement 250 prepared by the third party 232, in accordance with the disclosed embodiments. The third party 232 generates the report statement 250 from the returned inserts 260 for each magazine by querying the database 285 and sent the report statement 250 to the magazine company 205. The report statement 250 includes amount received 565, price 560, minus processing fee 570, and amount remitted 575. Each magazine publisher receives the report statement 250 periodically.

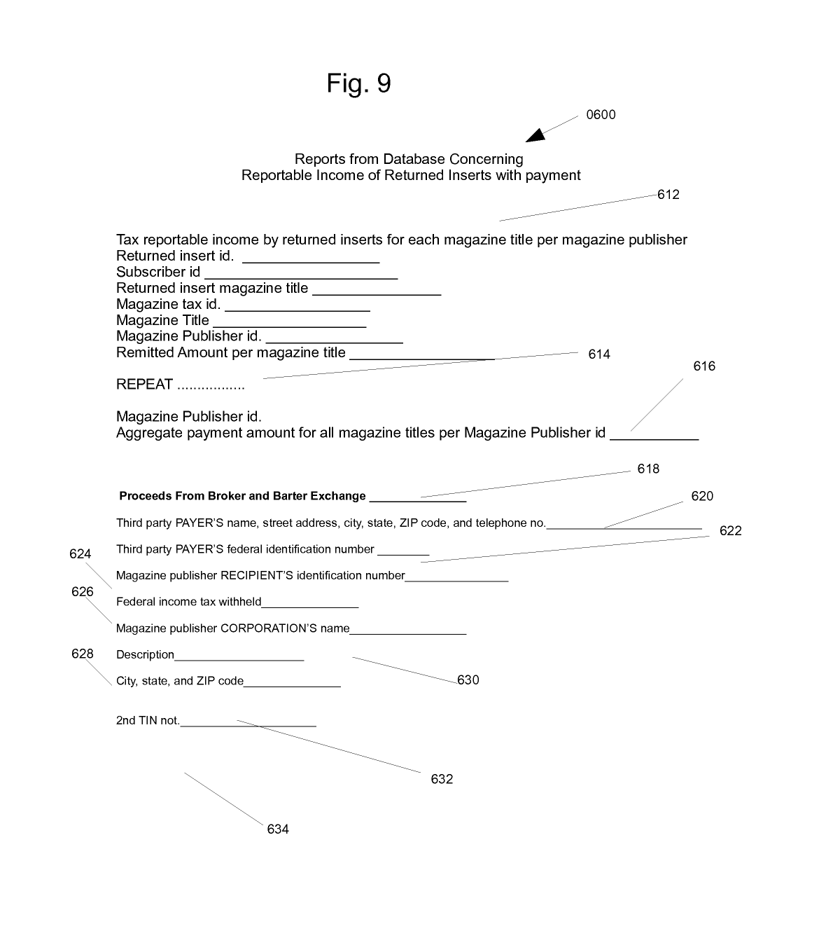

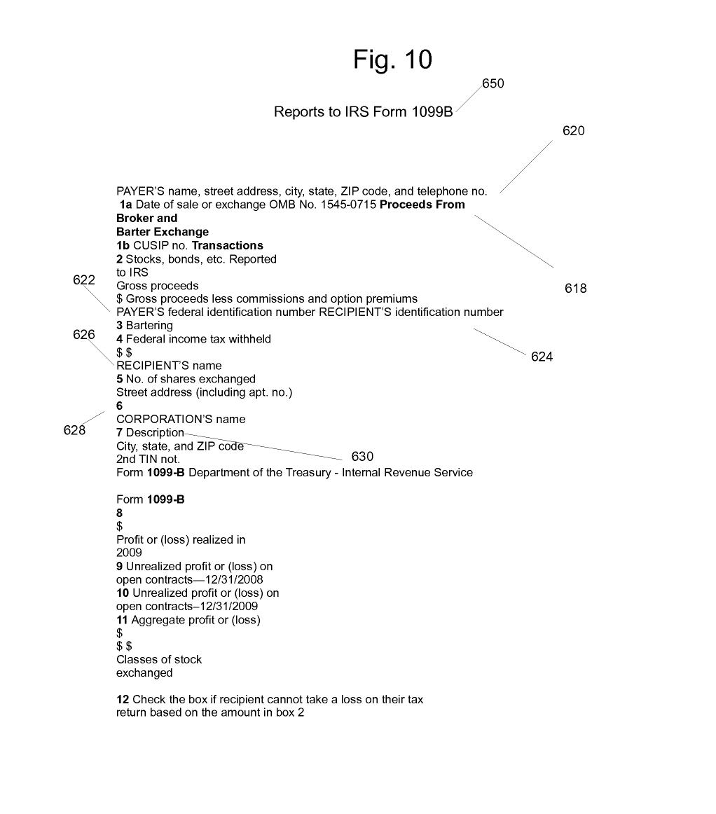

The cash payment 265 received from each magazine company 205 can also be reported as reportable income 275 to the IRS 290 for each respective magazine, as shown at block 350. FIGS. 9-10 illustrate an exemplary report form 600 and 650 sent to the IRS 290 with respect to the cash payment received for each returned inserts 260, in accordance with the disclosed embodiments. The reports 600 and 650 can be sent to the IRS 290 and each magazine publisher periodically in order to establish that the reportable income 275 from the inserts 225 is reported to the IRS 290. FIG. 9 illustrate the report 600 from the database 285 concerning the reportable income 275 of the returned inserts 260 with payment. A query can be performed where each returned insert 260 payment by the magazine title 430 is added up per magazine publisher. The total payments received from the returned inserts 260 per magazine publisher 612 can be reported to the IRS 290 with the form 1099b, as shown in FIG. 10.

The reports 600 and 650 includes data for example, proceeds from broker and barter exchange 618, third party PAYER'S name, street address, city, state, ZIP code, and telephone number 620, third party PAYER'S federal identification number 622, magazine publisher RECIPIENT'S identification number 624, federal income tax withheld 626, magazine publisher corporation's name 628, description 630, city, state, and ZIP code 632, and 2nd TIN not 634. The reports 600 and 650 further includes aggregate payment amount for all magazine titles per magazine publisher ID 616. The data with respect to the report form 600 and 650 can be obtained by querying the database 285.

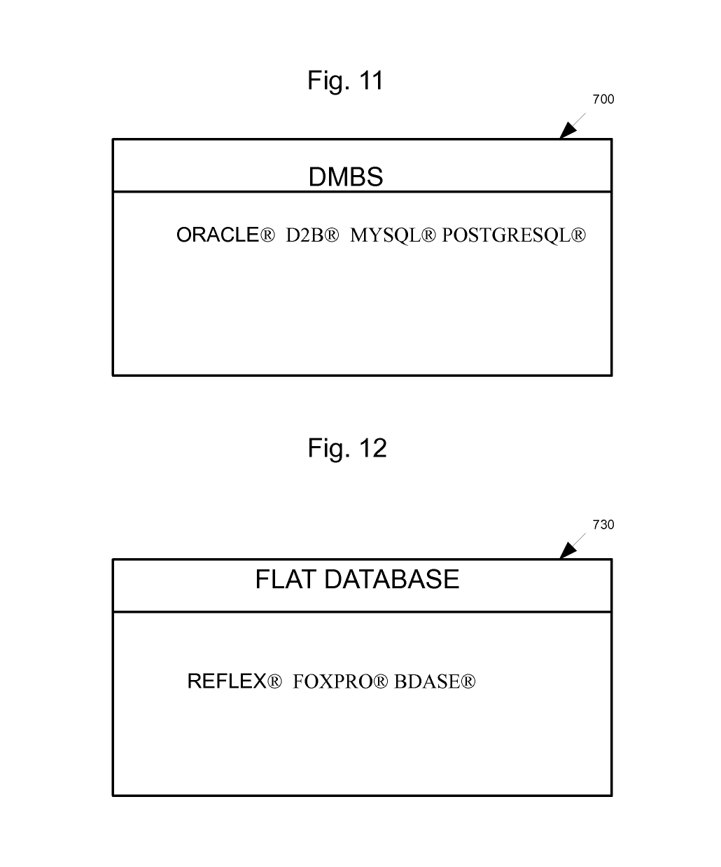

FIGS. 11-12 illustrate an exemplary open source database management system (DBMS) 700 and a flat database 730 capable of generating the reports 600 and 650 for the magazine company 205 and reports the reportable income 275 to the IRS 290, in accordance with the disclosed embodiments. The open source database management system 700 can be for example, commercial Oracle or DB2 and open source postregSQL and MySQL, all are based on SQL, depending upon design consideration. The data from the inserts 225 and the swap placement order 240 can be recorded into the DBMS 700. The data input partially consist of inputs of the self-mailer inserts 225, the returned self-mailer 260, the new subscribers 294 and the magazine title 430. After data is placed into the DBMS 700 the reports 600 and 650 can be generated for the magazines statements and reports to the IRS 290 as the tax reportable income 275 for each magazine. The flat database 730 such as, for example, REFLEX, DBASE OR FOXPRO may also be utilized for generating filing reports.

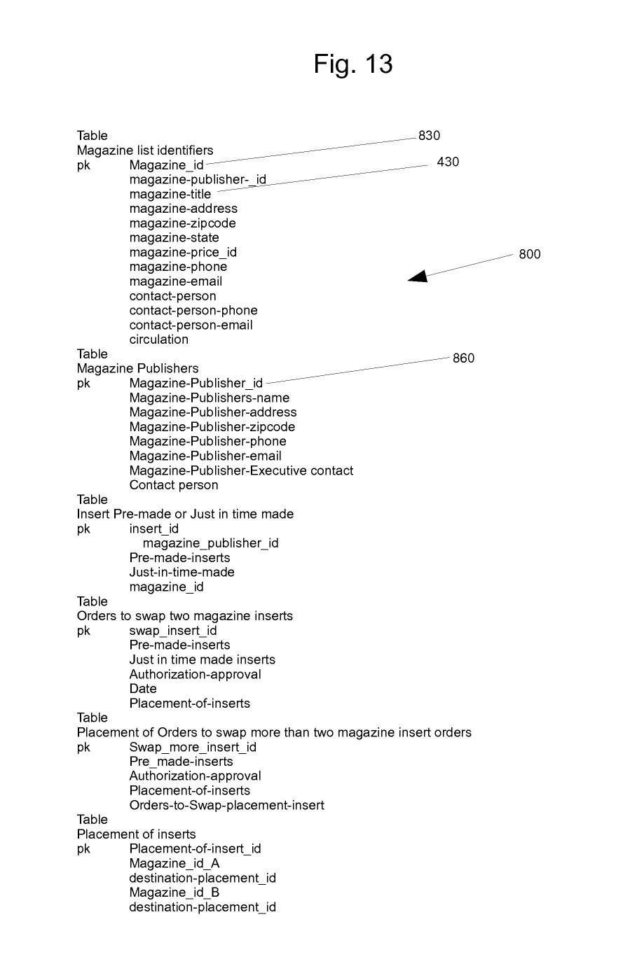

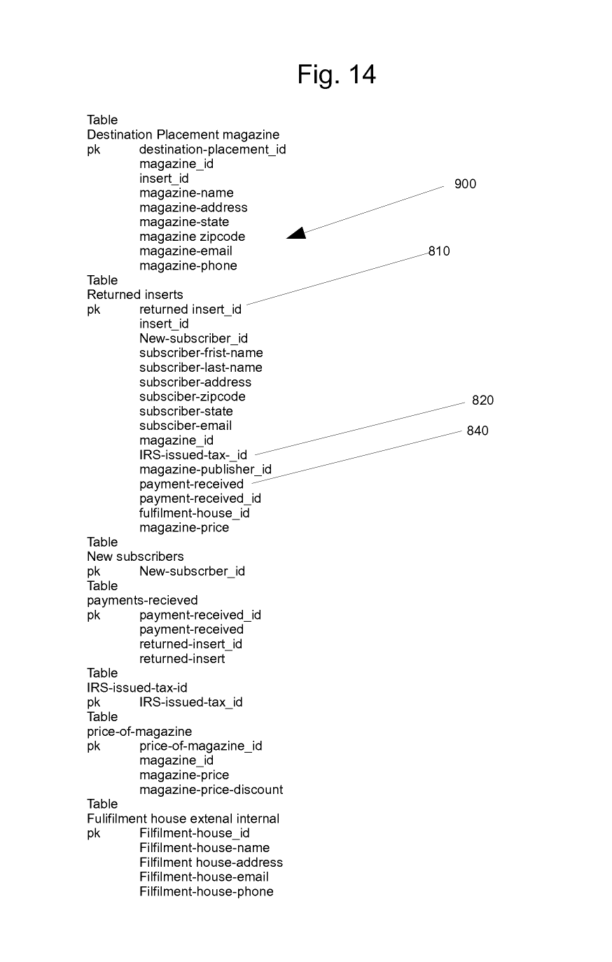

FIGS. 13-14 illustrates an exemplary view of a database schema 800 and 900 for taking in data and generating reports for the magazine company 205 and the IRS 290, in accordance with the disclosed embodiments. In general, a database schema of a database system is its structure described in a formal language supported by the database management system (DBMS) and refers to the organization of data to create a blueprint of how a database will be constructed (divided into database tables). The formal definition of database schema is a set of formulas (sentences) that specify integrity constraints imposed on the database. “A database schema specifies, based on the database administrator's knowledge of possible applications, the facts that can enter the database, or those of interest to the possible end-users.”

The database schema 800 and 900 is based on DBMS and SQL for taking in data and generating the reports 600 and 650 for the magazine statements and reports to the IRS 290 of the reportable income 275. The data for querying the database 285 for the reportable income 275 and to file 1099b forms with the IRS 290 includes returned_insert_id 810, payment-received 840, magazine_id 830, magazine title 430, magazine_publisher_id 860, IRS-issued_id 820. Such an approach can reestablish the magazine insert swapping industry where the magazines can swap the inserts 225 between themselves from different magazine publishers, and still satisfy compliance with the IRS 290 ruling that inserts 225 are tax reportable incomes 275.

### How to Use the Invention

This section teaches how to used the method claimed subject matter. The problem addressed by the invention are many as can be seen by those skilled in this art, the use of the method part of invention is to allows an industry of Exchanging-Swapping of magazine inserts between different magazine publisher that once existed to come back into existence is needed. The IRS ruled that bartering of insert that involved no money where tax reportable income and required 1099b form to be filled out. This IRS ruling collapsed the exchanging of inserts industry. The use of the subject matter of the invention as Claimed in claim 1 an its depend claims shows using a self mailer and by Exchanging self mailers inserts between different magazine by agreement on a per-inquiry sale or barter basis that solicits a new subscriber and by processing a order, receiving inserts and sending out reports to magazine and the IRS, one can use this to address the above problem that is to bring back a swapping of insert industry that solicits magazine subscriptions that once exited but no longer exits. Still another use is for a third party to handle and process millions of returned inserts from different magazines simultaneously as Claimed in claim 1 an its depend claims shows using a self mailer 225 and by processing a order 310, receiving inserts 320 and sending out reports to magazine 340 and the IRS 350, one can use the claimed subject matter to address the above problem that is for a third party to handle and process millions of returned inserts from different magazines simultaneously. Still another use is to have simultaneously to arrange the placement of inserts into thousands of different magazines simultaneously where everything is accounted for as Claimed in claim 1 an its depend claims shows using a self mailer 225 and by processing a order 310, receiving inserts 320 and sending out reports to magazine 340 and the IRS 350 one can use the claimed subject matter to address the above problem that is for to have simultaneously to arrange the placement of inserts into thousands of different magazines simultaneously where everything is accounted for. Another use of the invention for subscribers in one magazine to be solicited by another magazine. Still another use is for one magazine to acquire new subscribers from another magazine.

Now turning to the system this section teaches how to used system claimed subject matter. Exchanging-Swapping of magazine inserts between different magazine publisher that once existed to come back into existence is needed. The use of the subject matter of the invention as Claimed in claim 11 an its depend claims shows the self-mailer 225 insert management system 200 includes a third party server 210, with a self-mailer insert management module 152, and a database 285 connected to an internal revenue service 290 and a magazine company 205 via a network 292 one can use this to address the above problem that is to bring back a swapping of insert industry. By using such a system one can record exchanges and reportable income satisfying IRS reporting requirements. Still another use is for a third party to handle and process millions of returned inserts from different magazines simultaneously as The use of the subject matter of the invention as Claimed in claim 11 an its depend claims shows the self-mailer 225 insert management system 200 includes a third party server 210, with a self-mailer insert management module 152, and a database 285 connected to an internal revenue service 290 and a magazine company 205 via a network 292 one can use this to address the above problem that is for a third party to handle and process millions of returned inserts from different magazines simultaneously Still another use is to have simultaneously to arrange the placement of inserts into thousands of different magazines simultaneously where everything is accounted for. The use of the subject matter of the invention as Claimed in claim 11 an its depend claims shows the self-mailer insert management system includes a third party server, with a self-mailer insert management module, and a database connected to an internal revenue service and a magazine company via a network one can use this to address the above problem that is to have simultaneously to arrange the placement of inserts into thousands of different magazines simultaneously where everything is accounted for. Another use of the invention for subscribers in one magazine to be solicited by another magazine. Still another use is for one magazine to acquire new subscribers from another magazine. In both cases the system part can handle the situation to keep track of everything.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for swapping self-mailer inserts, said method comprising:
exchanging self mailers inserts between different magazine by agreement on a per-inquiry sale basis that solicits a new subscriber;
processing a swapping insert placement order for swapping at least two self-mailer inserts having a return address addressed to a third party between at least two magazines by said third party;
recording data indicative of said swapping insert placement order to a database;
receiving a returned insert along with a cash payment from a new subscriber for subscribing a new magazine by said third party and thereafter record data indicative of said returned insert along with said cash payment to said database; and
sending a report statement including said cash payment enclosed with said returned insert to a magazine company by querying said database in order to thereafter report said cash payment received from said returned insert for each magazine as a reportable income to an internal revenue service.

2. The method of claim 1 further comprising configuring said self-mailer insert to include an enclosed envelope having a check mailed by said subscriber for subscription of said new magazine.

3. The method of claim 1 wherein said self-mailer insert comprises at least one of the following types of data:
data indicative of a third party address;
data indicative of an insert identification;
data indicative of a check and/or or a credit card information;
data indicative of a new subscriber address; and
data indicative of an insert magazine title.

4. The method of claim 1 further comprising arranging said swap placement order for swapping said self-mailer inserts between said at least two magazines by said third party.

5. The method of claim 1 further comprising making said self-mailer insert as a layout sent to a receiving magazine wherein said receiving magazine makes and insert said self-mailer insert into said magazine.

6. The method of claim 1 further comprising pre-making said self-mailer insert by an insertion requesting magazine company and send said self-mailer insert to a receiving placement magazine company for insertion to said receiving magazine.

7. The method of claim 1 wherein said report statement comprises at least one of the following types of data:
data indicative of an amount received,
data indicative of a price minus processing fee, and
data indicative of a remitted amount.

8. The method of claim 1 wherein said exchanging comprises exchanging self mailers inserts between different magazine by agreement on a per-inquiry barter basis that solicits a new subscriber.

9. The method of claim 1 further comprising querying said reportable income with respect to said returned insert with said cash payment from said database.

10. The method of claim 1 wherein said database comprises at least one of the following types of database:
a commercial and open source database management unit; or
a flat database.

11. A system for swapping self-mailer inserts, said system comprising:
a self-mailer insert management system that includes a third party server, with a self-mailer insert management module, and a database connected to an internal revenue service and a magazine company via a network;
the self-mailer insert management module includes a self-mailer insert swapping and placement unit that places and swaps inserts, a return insert-cash payment processing unit that process payment of return inserts, a internal revenue service reporting unit that complies reports for the internal revenue service.

12. The system of claim 11, wherein said network is a data-processing system that further comprises a central processor, a main memory, an input/output controller, a keyboard, a pointing device, such as a mouse, track ball, a display device, a mass storage and a universal serial bus peripheral connection.

13. The system to claim 11, wherein said self-mailer insert management module resides in a computer software system that further comprises an operating system, interface and software application interface.

14. The system of claim 11, wherein said self-mailer insert swapping and placement unit that places and swaps inserts further comprises a self-mailer insert which stores data of self mailers, a swapping insert placement order which stores data of orders placed.

15. The system of claim 14, wherein said self-mailer insert further comprises a check which stores data of checks, and a return address which stores data of returned address from returned address of inserts.

16. The system of claim 11, wherein said return insert-cash payment processing unit further comprises a returned insert which stores data of returned inserts, and a cash payment which stores data of cash payments.

17. The system of claim 11, wherein said internal revenue service reporting unit that complies reports for the internal revenue service further comprises a reportable income which stores data of reportable income.

18. The system of claim 11, wherein said a report statement processing unit that process report statements further comprises a report statement which stores data of report statements.

19. The system according to claim 11, wherein said database further comprises a database schema for taking in data and generating reports for a magazine company and said irs internal revenue service.

20. The system of claim 11, wherein said database further comprising a data base management system.
